(19) United States
(12) Patent Application Publication
(10) Pub. No.: US 2004/0143381 A1
(43) Pub. Date: Jul. 22, 2004

(54) Switching a turn signal indicator on or off

(76) Inventors: Uwe Regensburger, Ostfildern (DE); Bernd Woltermann, Fellbach (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/700,675

(22) Filed: Nov. 5, 2003

(30) Foreign Application Priority Data
Nov. 5, 2002 (DE) 102 51 357.0

(51) Int. Cl. G06F 17/00

(52) U.S. Cl. 701/36; 701/1; 340/465

(57) ABSTRACT

A method of automatically switching a turn indicator on a vehicle on or off, whereby ambient data about the vehicle is detected for determining the location of the vehicle. On the basis of this ambient data, changes in lane and/or direction of travel are determined. Before a change in lane or direction of travel, the turn indicator is turned on and turned off after changing lanes and/or direction of travel.

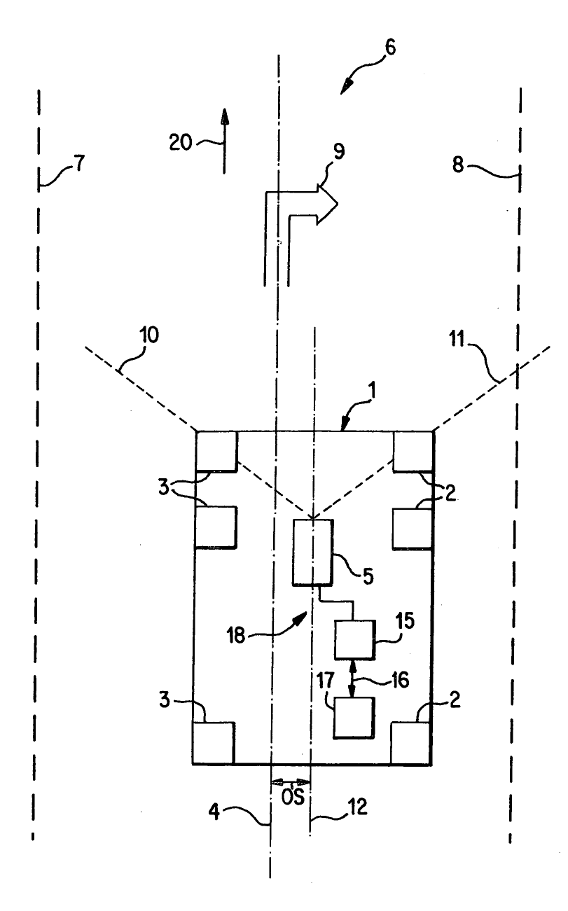

### BACKGROUND AND SUMMARY OF THE INVENTION

This application claims the priority of German Patent document 102 51 357.0, filed Nov. 5, 2002, the disclosure of which is expressly incorporated by reference therein.

This invention relates to a method of automatically switching a turn signal indicator on a motor vehicle on or off.

The law requires that lane changes be indicated with the help of a turn indicator on a motor vehicle because this helps the following traffic to promptly recognize the driving intent of the vehicle driving in front and thus helps to prevent dangerous traffic situations. Nevertheless in road traffic, lane changing maneuvers are performed without first operating the turn indicator or blinker—whether from convenience or lack of attention. This results in hazardous situations because the following traffic is unable to adjust to the lane change. Furthermore, after changing lanes, the turn indicator frequently is not turned off again. Therefore, drivers in the following traffic are irritated because they do not know whether or not the driver still intends to change lanes.

Today there is a mechanism in vehicles for automatically turning a turn indicator back off after it has been turned on and after the change of direction has been implemented, as disclosed in German Patent Application DE 27 25 805 A1, for example. However, this presupposes that a certain minimum steering wheel angle has been implemented and that the steering wheel is also turned back again, which is rarely the case in less dynamic lane change maneuvers. For this reason, it frequently happens that the turn indicator is not turned off after a lane changing maneuver has been executed.

German Patent Application 42 38 538 A1 discloses a configuration for controlling the duration of flashing of the turn indicator in short-term deployment in which the blinkers flash several times in short-term deployment of the turn indicator blinking process. In its vehicles, DAIMLERCHRYSLER AG offers a “convenient jog control.” With this circuit, the driver clicks on the turn indicator and the blinker signal is automatically turned on to flash three times.

The solution offered by German Patent Application DE 42 38 538 A1 and/or the solution offered by DAIMLERCHRYSLER simplifies driving when changing lanes because the driver need no longer turn off the turn light indicator after it has been turned on. However, this does not offer any help for the situation when the turn indicator has not even been turned on when changing lanes.

German Patent DE 195 07 957 C1 discloses a vehicle having an optical scanning device mounted on the side for non-contact scanning of a lateral area of the road with a downstream analyzer unit. This system is used mainly for detecting lanes and/or monitoring the rear area. Lane recognition is used for automatically keeping the vehicle in the lane or as a warning function on leaving the lane. The warning function on leaving the lane generates a visual, acoustic and/or haptic warning when it recognizes that the vehicle is about to leave the lane and/or to drive over lane markers.

The lane recognition may in particular differentiate whether it is a lane marker or an adjacent driving lane or emergency lane or a curb edge or, in the absence of an attached roadway edge, an adjacent green strip, etc. By additional detection of the transverse velocity of the vehicle, the warning message can be adapted better to the driving situation.

The object of the present invention is to discover a method which will make it possible to automatically switch the turn indicator of the vehicle on and off.

According to the present invention, lane changes and/or changes in direction of travel are determined on the basis of ambient data. The turn indicator 2, 3 is turned on before a lane change or a change in the direction of travel and/or the turn indicator is turned off after changing lanes or direction of travel.

The inventive method makes it possible for the following road users to be informed of imminent or implemented lane changes or changes in direction of travel, regardless of how conscientious the driver is. This is true in particular when changing lanes for passing another vehicle or when making a turn. Traffic safety is thus increased by using this method.

For the driver, the method according to this invention increases driving convenience, because the turn indicators are turned on and off automatically.

Determination of the future lane position of the vehicle by lane recognition permits early detection of the fact that a lane marker has been partially and/or completely crossed. Thus, automatically turning the turn indicator on and/or off may be adapted to the prevailing traffic situation.

The point in time for turning the turn indicators on or off can be adapted to different driving conditions, such as freeway or rural road by preselecting the route length to be calculated in advance.

Since the turn indicator is automatically turned off after completing a lane change, i.e., crossing a lane, following drivers are no longer irritated by turn indicators that mistakenly are kept flashing by the driver.

The inventive method also makes it possible to turn off the turn indicator when changing lanes with a small steering angle, because the basis of this method is the lane change and not the change in the position of the steering wheel.

Another advantage of the inventive method is that by means of direction arrow recognition, the vehicle reproduces the traffic guidance preselected by the driver via the turn indicators of the vehicle. This facilitates an overview of the traffic situation by the other road users. For example, for a vehicle in a turn lane, the turn indicator will be turned on according to the direction of travel indicated by the direction arrow recognized on the road surface.

Early recognition of a passing maneuver by determination of distance and relative speed and by detection of objects on adjacent lanes is advantageous. The turn indicator can thus be turned on at an early point in time in passing situations.

Another advantage of the inventive method is that it includes a vehicle navigation system. Therefore, the turn indicator may be turned on or turned off independently of or in support of lane recognition.

The inventive method is advantageous in particular when vehicle position determinations in the centimeter range are possible and accurate digital maps covering the area are available accordingly.

The combined method utilizing data from the vehicle navigation system and lane recognition has the advantage that the inventive method has a greater reliability.

Another advantage is that the digital map is adjusted in the case of repeated manual intervention by the driver at a certain location of the vehicle, because this data is stored and analyzed. Thus, the automatic turning on and/or off of the turn indicator in traffic maneuvers, which are not imaged on the digital map, can be adapted accordingly. This method is suitable in particular for lane changes or road changes because of construction in areas the driver must pass by frequently.

It is also advantageous to adapt the turning on or off of the turn indicator to the driving style of the driver by recording and analyzing maneuvers made by the driver. To do so, in particular the point in time and/or the location of the vehicle when the turn indicator is turned on and/or off manually is/are detected when changing lanes or direction of travel.

Other objects, advantages and novel features of the present invention will become apparent from the following detailed description of the invention when considered in conjunction with the accompanying drawing.

### BRIEF DESCRIPTION OF THE DRAWING

The FIGURE shows a device for implementing the inventive method.

### DETAILED DESCRIPTION OF THE PREFERRED EMBODIMENT

The device in the FIGURE has a vehicle 1 with turn indicators 2, 3 and an optical scanning device 5 as part of a lane recognition unit 18. The vehicle is traveling in a lane 6 delimited by a left lane marking 7 and a right lane marking 8, forming the respective lane borders. A turn arrow 9 is illustrated on the road surface of lane 6.

The lane recognition unit 18 used in implementing the inventive method is essentially known and is disclosed in German Patent 195 07 957 C1, for example, reference being made explicitly at this point to the embodiment of the lane recognition unit 18 according to German Patent 195 07 957 C1.

The lane recognition unit 18 has an optical scanning device 5 and an analyzer unit 15, where the analyzer unit 15 is connected by a data bus 16 to the control unit 17 of the turn indicators 2, 3. By appropriate signals, the analyzer unit 15 controls the turning on or off of the turn indicator 2, which is provided on the right side of the vehicle, and of the turn indicator 3, which is provided on the left side of the vehicle, by means of the controller 17.

For the sake of simplicity, the connections between the controller 17 and the turn indicators 2, 3 are not shown in the FIGURE.

The optical scanning device 5 has a plurality of infrared transmitter elements arranged in a row and a respective CCD (charge coupled device) array. A downstream measurement unit performs the transit time measurement, the contrast measurement and the contour recognition as disclosed in German Patent DE 195 07 957 C1. With this optical scanning device 5, a lane-leaving warning function, an automatic lane holding function and an environment monitoring function are made available to the vehicle 1. The lane recognition unit 18 recognizes different types of lane borders such as lane edging—for example, a curb or green strip—and in particular lane markings 7, 8.

The analyzer unit 15 of the lane recognition unit 18 functions by determining the lane position of the vehicle 1 via an offset value OS of the position of the vehicle 1. The offset value OS of the position of the vehicle 1 in a lane 6 is given here by the deviation of the center 4 of the lane from the longitudinal axis 12 of the vehicle. The offset value OS has a plus or minus sign and may be either positive or negative when the longitudinal axis 12 of the vehicle in the direction of travel 20 as seen to the left of the center 4 of the lane 6 in which the vehicle is driving at the moment, and the offset value OS has the other sign when the longitudinal axis 12 of the vehicle is in the direction of travel 20 as seen to the right of the center 4 of the lane. If the longitudinal axis 12 of the vehicle travels beyond the center 4 of the lane, the sign of the offset value OS changes. This takes place when the vehicle 1 changes to the adjacent lane.

The optical scanning device 5 has a scanning unit aimed toward the front to recognize direction of travel arrows on the road surface, such as turn arrows 9 and traffic signs such as turn indicators or signs indicating approaching junctions. In addition, the optical scanning device 5 detects the objects present in the space detected, where the objects in a conical scanning area at each scanning time, indicated by dotted lines 10, 11 in the FIGURE, are detected. Detection includes in particular other road users. The scanning information or scanning images determined at the individual scanning times are stored and compiled to form a tubular space of the individual scanned areas when driving the vehicle.

The distance from vehicles traveling in front is measured by an essentially known radar measurement device, not depicted in greater detail here, by the transit time method. The relative speed in relation to a vehicle traveling in front is determined by the Doppler effect.

Furthermore, the vehicle 1 has a traditional navigation system, which uses a digital map and a position determining unit such as GPS (Global Positioning System) to image the vehicle 1 on the digital map. In this way the vehicle 1 is capable of providing the driver with route information and/or assuming the navigation function. In particular the navigation system can provide information on the local environment such as intersections, highway exit ramps, one-lane roads, etc.

The analyzer unit 15 can adapt the point in time for turning the turn indicator 2, 3 on or off to the driving habits of the driver on the basis of conventional statistical methods such as those using neural networks.

In the inventive method of automatically turning a turn indicator 2, 3 of a vehicle 1 on or off, ambient data about the vehicle 1 is detected for determining the position of the vehicle. Lane changes and/or direction of travel changes are determined on the basis of this ambient data. Before changing lanes or direction of travel, the turn indicator 2, 3 is turned on or off after changing lanes and/or changing direction of travel.

Detection of ambient data about the vehicle 1 includes lane recognition. In doing so, the lane position of the vehicle 1 is calculated in advance using a cyclic algorithm for a preselectable route length. Then the lane position of the vehicle 1 which has been calculated in advance is used to determine whether the vehicle 1 has completely and/or partially driven over a lane marking 7 and/or 8 of the lane 6. If the advance calculations show that the lane will be crossed partially or entirely, the corresponding turn indicator 2 or 3 is turned on automatically.

The turn indicator 2, 3 is not turned on when the preliminary calculation has shown that the lane border 7, 8 will be crossed at least in part, but the respective lane border at the same time marks the edge of the road and there is no drivable area on the other side of the lane border 7, 8. This is the case with the left lane on a highway, for example, because to the left of the left lane border there is only the center guardrail. Whether there is a drivable area on the other side of a lane border can also be determined by corresponding image processing in the lane recognition device 18 or on the basis of a high-precision navigation system in conjunction with a digital map which indicates the drivable areas.

The analyzer unit 15 of the lane recognition device 18 operates in such a way that a future lane position of the vehicle 1 is calculated in advance cyclically on the basis of the instantaneous offset value OS from the center 4 of the lane and/or the yaw rate and/or the width of the lane and/or the speed of the vehicle, for example, by extrapolation of the prevailing lane position on the basis of the values detected.

The path of the vehicle 1, which is composed of the predetermined lane positions, is determined in advance for a preselectable route length. This preselectable route length is defined as a function of speed. At average speeds, the lane guidance is calculated for approximately 50 meters in advance. This corresponds to a cyclic computation cycle of 40 milliseconds.

At higher speeds of the vehicle 1, the route length to be calculated in advance is set upwards to obtain the same point in time for flashing the lights in relation to the slow speeds when changing lanes. This reflects, for example, the difference between turning the turn indicator 2, 3 on when driving on a highway and turning the turn indicator 2, 3 on when driving on a rural road.

Completely or partially crossing a lane marking 7, 8 is determined by the offset value OS of the position of the vehicle 1. The offset value OS is the deviation of the center 4 of the lane from the longitudinal axis 12 of the vehicle, whereby the lane width of the lane 6 and the vehicle width also enter into the calculation for determining whether the lane has been completely or partially crossed. On the basis of this information, it is possible to calculate whether the vehicle has partially or completely crossed a lane border.

Partial crossing of a lane border includes any portion of the vehicle being above the lane marking 7, 8 without one or more wheels of the vehicle having crossed the lane border. Complete crossing of a lane border 7, 8 corresponds to changing lanes, where all wheels of the vehicle 1 have crossed the lane border 7, 8 and no part of the vehicle is above the lane border 7, 8. Crossing a lane is characterized by an increase and subsequent decrease in the offset value OS plus a change in the plus or minus sign.

The lane recognition unit 18 detects the fact that a lane border has been crossed on the basis of the instantaneous offset value OS, i.e., a complete lane change has occurred, and then a turn indicator 2 or 3 which has been turned on is now turned off. This turning off may also take place with a time lag after the end of the lane change, for which any desired period of time may be preselected.

The optical scanning device 5 also recognizes the direction arrows 9 on the road surface or on traffic signs. The turn indicator 2, 3 is turned on or off as a function of the direction of travel indicated by the direction arrow recognized. Thus, when the turn arrow 9 with the direction of travel “to the right” is recognized on the road surface on which the vehicle 1 is located, the turn indicator 2 is set for “right” accordingly. Or if the vehicle 1 having a turn indicator 2, 3 that has been turned on is located on a road surface having a “straight ahead” direction arrow, then a turn indicator 2, 3 that has been turned on is now turned off.

Switching on the turn indicator 2, 3 in passing maneuvers is supported by the measurement of the distance and relative speed in relation to the vehicle traveling in front as well as the object monitoring of an adjacent lane. The passing maneuver is characterized by a constant or increasing relative speed and by a shortening of the distance from the vehicle in front plus a free adjacent lane. The characterization is implemented on the basis of the determination of threshold values for the distance, the relative speed and the free space on the adjacent lane. If the relative speed exceeds a predetermined relative speed threshold value and/or the distance from the vehicle in front exceeds a predetermined distance threshold value and if the space on the adjacent lane monitored is free, then it is concluded that a passing maneuver is imminent and the respective turn indicator 2 or 3 is turned on. Turning on the turn indicator 2, 3 according to the method implemented as described above also supports promptly turning on the turn indicator 2, 3 when changing lanes.

In addition, this method is supported by the on-board navigation system. Based on the information in the digital map regarding trip routes, road layout, lanes, intersections, turns and location determinations, the turn indicator 2, 3 is turned on or off according to the digital map.

To adapt the turning of the turn indicator 2, 3 on or off to the driving style of the particular driver, the manual turning of the turn indicator 2, 3 on or off is detected. This refers to the determination of the point in time when the driver turns on the turn indicator 2, 3 before changing lanes or changing direction of travel or the time when he turns it off after having changed lanes or direction of travel.

To further adapt the turning on or off of the turn indicator 2, 3 to the driving style of the driver, the distance between a first vehicle when the turn indicator 2 or 3 is turned on or off and a second vehicle position when changing lanes or direction of travel is additionally determined when there is an on-board navigation system. The distance here is determined by means of the digital map and the vehicle position determined at the time of manually turning the indicator on or off. The second vehicle position corresponds, for example, to the geographic location of an intersection, a lane which turns off or a lane which ends, thus prompting a lane change.

As a function of the data given above, the point in time for turning the turn indicator 2, 3 on or off, which is determined by the method steps according to this invention, is adapted to the driving style of the driver. The adaptation to the driving style of the driver is limited by the fact that defined requirements must also be met when automatically turning the turn indicator 2, 3 on or off.

For this adaptation, the data thus compiled is stored and analyzed by statistical methods such as those using neural networks. In this way, the point in time that is optimum for the driver for turning the turn indicator off is determined. This analysis can also be performed for just a short period of time or for a certain number of kilometers driven, depending on the computation capacity of the analyzer unit 15.

By means of the vehicle navigation system, a determination is also performed as to whether manually turning the turn indicator 2, 3 on or off by the driver deviates significantly from the automatic turning on or off. This deviation is stored in the digital map together with the vehicle position and a frequency counter. If the driver performs a manual intervention repeatedly at the same location of the vehicle, this is simulated on the digital map via the frequency counter.

If the frequency is high, the turn indicator 2, 3 is turned on or off on the basis of this deviation. This makes it possible for changes in traffic control, which are not reflected on the digital map, to be taken into account in turning the turn indicator 2, 3 on or off. Changes in traffic control would include, for example, construction sites not included on the digital map. If this construction site is located on the driver's way to work, the driver will drive over this position of the vehicle repeatedly with the same deviation and thus it will be stored accordingly in the digital map.

A single optical scanning device 5 directed toward the front is sufficient for implementing the inventive method. It can perform the functions of lane recognition as well as optionally sign recognition, driving lane recognition, distance measurement, relative speed measurement and adjacent lane and object recognition.

The distance measurement can be performed by using a monoscopic camera by means of optical flow and calibration accordingly. A transit time measurement using infrared sensors may also be used with a monoscopic camera. When using stereoscopic cameras, the distance measurement may be performed by the triangulation method.

Virtual lane recognition may also be used in the case of multiple-lane roads and numerous road users. In this method, a virtual road map having virtual lane markings 7, 8 is generated from the trajectories of the other road users. This method is recommended in particular when the existing lane markings 7, 8 are poor or inadequate, e.g., because of or in the vicinity of construction sites.

Because of the quality of the road maps currently available and the use of trip routing, the vehicle navigation system is used supportively for lane recognition or direction arrow recognition in the inventive method. Switching the turn indicator 2, 3 on or off via the vehicle navigation system may, however, also be used independently of the lane recognition method or the direction arrow recognition method.

This will be the case in particular when the commercially available digital maps from NAVTEC (Navigation Technologies) or Teleatlas also permit a lane determination on the corresponding road in addition to a road determination. This greater resolution of the digital map allows the turn indicator 2, 3 to be turned on or off when changing lanes, especially in passing maneuvers, and not only because of the course of the road.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of automatically switching a turn indicator on a vehicle on or off, comprising the steps of:
detecting ambient data about the vehicle for determining the location of the vehicle,
determining on the basis of the ambient data, at least one of lane changing and direction changing information, and
switching on the turn indicator before changing one of lanes and directions and switching off the turn indicator after changing one of lanes and directions.

2. The method as claimed in claim 1, wherein
lane recognition is performed on the basis of the ambient data about the vehicle by determining the position of the vehicle in the lane,
the position of the vehicle is calculated in advance for a preselectable route length,
the position calculated in advance is used to determine whether a lane border of the lane has been completely or partially crossed,
the turn indicator is turned on when complete or partial crossing of the lane is detected.

3. The method as claimed in claim 1, wherein a lane recognition is performed on the basis of the ambient data about the vehicle in order to determine the position of the vehicle in the lane, and wherein the turn indicator is automatically turned off after completely or partially crossing a lane border of the lane.

4. The method as claimed in claim 2 wherein
an offset value (OS) is determined which corresponds to the deviation of a center of the lane being driven on instantaneously from the longitudinal axis of the vehicle, and
crossing of the lane border of the lane is recognized by an increase in amount and a subsequent decline in the offset value (OS) combined with a change in direction of the offset value (OS).

5. The method as claimed in claim 1 wherein the detection of ambient data includes recognition of at least one of direction arrows on a road surface and traffic signs, and wherein the turn indicator is automatically turned on in accordance with the direction of travel as indicated by the direction arrow recognized.

6. The method as claimed in claim 1 wherein
the detection of ambient data includes a recognition of objects in an adjacent lane beside the vehicle,
at least one of distance and relative speed in relation to a vehicle in front is detected, and
if the adjacent lane is free, the turn indicator is switched on when at least one of the distance from the vehicle in front falls below a distance threshold value and the relative speed in relation to the vehicle in front exceeds a relative speed threshold value.

7. The method as claimed in claim 1 wherein a point in time of automatically turning the turn indicator on or off before or after changing lanes or direction of travel during operation of the vehicle is altered as a function of a second point in time before or after a change in lane or direction of travel as selected by the driver in manually turning the turn indicator on or off.

8. The method as claimed in claim 1 wherein,
the detection of ambient data includes satellite-supported vehicle position detection,
determination of the lane or road being driven on the basis of a digital map and the vehicle position, and
turning the turn indicator on or off according to the course of the lane or road ahead.

9. The method as claimed in claim 8, wherein, after the driver has repeatedly turned the turn indicator on or off when the vehicle is in essentially the same location, the turn indicator is automatically turned on or off on reaching said same location of the vehicle.

10. The method as claimed in claim 8 wherein, when the turn indicator is manually turned on or off by the driver in a first location of the vehicle, the distance between the first location of the vehicle and the second location of the vehicle reached at the time when the vehicle changes lanes or direction of travel is determined and the time when the turn indicator is automatically turned on or off is varied as a function of the distance that is determined.

11. The method as claimed in claim 10, wherein at least one of a first vehicle location when the turn indicator is manually turned on or off by the driver is stored and the distance between the first location of the vehicle and a second location of the vehicle is stored in the digital map.

12. A method of automatically controlling operation of a vehicle turn signal indicator comprising the steps of:
detecting the environment of said vehicle,
determining the orientation of said vehicle relative to said environment, and
changing a state of operation of said turn signal indicator as a function of said orientation.

13. The method according to claim 12 wherein the environment of said vehicle includes information covering a surface being traveled by said vehicle.

14. The method according to claim 12 wherein the orientation includes a position of said vehicle on a surface being traveled.

15. The method according to claim 14 wherein the orientation further includes a determination of boundaries of said surface.

16. The method according to claim 15 wherein said boundaries includes sides of the road and lane markings.

17. The method according to claim 12 wherein said orientation includes at least one of a speed of said vehicle relative to a preceding vehicle, a distance between said vehicle and a preceding vehicle, and a determination of a partial or complete lane change.
